(19) United States
(12) Patent Application Publication
(10) Pub. No.: US 2008/0148993 A1
(43) Pub. Date: Jun. 26, 2008

(54) Hybrid propulsion system and method

(76) Inventor: Tom Mack, Cincinnati, OH (US)

Correspondence Address: ANDREWS KURTH LLP, 1350 I STREET, N.W., SUITE 1100, WASHINGTON, DC, 20005, US

(21) Appl. No.: 12/000,107

(22) Filed: Dec. 7, 2007

Related U.S. Application Data
(60) Provisional application No. 60/873,584, filed on Dec. 8, 2006.

(51) Int. Cl. B61C 7/04; B60W 20/00; B60K 6/20

(52) U.S. Cl. 105/35; 290/3; 290/16; 290/17; 701/20; 903/920

(57) ABSTRACT

A hybrid propulsion system includes a prime mover system, a driving system, an energy storage system, a regenerative braking system, and a control system usable to control operation of the prime mover, driving, energy storage, and regenerative braking systems. The control system receives inputs of geographic location, speed, and terrain features, and manages energy discharge and charge operations.

### CROSS-REFERENCE TO RELATED APPLICATION(S)

This application claims priority from U.S. Provisional Application 60/873,584 filed Dec. 8, 2006 entitled “Hybrid Propulsion System and Method” the content of which is incorporated herein in its entirety to the extent that it is consistent with this invention and application.

### TECHNICAL FIELD

The technical field is hybrid propulsion systems.

### BACKGROUND

Hybrid propulsion systems are used to power and propel a variety of vehicles. However, current hybrid propulsion systems require improvement to optimize performance.

### SUMMARY

What is disclosed is an improved hybrid propulsion system. In an embodiment, the hybrid propulsion system is optimized for use with a railroad locomotive.

Also disclosed is a locomotive propulsion system. The locomotive propulsion system includes one or more engine/generator sets, wherein engines of the engine/generator sets operate by burning one or more of ethanol, butanol, alcohol, and blends thereof, and hydrogen; traction motors electrically coupled to the engine/generator sets, wherein the traction motors operate in a motor mode to drive wheels to propel a locomotive, and operate in a generator mode to generate electrical power during locomotive braking periods; a main storage battery coupled to the engine/generator sets and the traction motors, wherein the engine/generator sets operate to provide an electrical charge to the main storage battery, wherein the traction motors operate in the generator mode to charge the main storage battery, and wherein the main storage battery provides electrical power to the traction motors; an electromechanical battery coupled to the electrical/generator sets and the traction motors, wherein the traction motors operate in a charging mode to charge the electro-mechanical battery, and wherein the battery operates in a boost mode to drive the traction motors; an energy dissipation unit coupled to the traction motors and operable to dissipate excess electrical power; and a predictive power system that uses locomotive location and mode of operation to determine an appropriate locomotive power setting.

Further disclosed is a hybrid propulsion system for a locomotive, where the locomotive operates in one of a motoring mode and a braking mode. The hybrid propulsion system includes a prime mover system comprising internal combustion engines coupled to electrical generators; an energy storage system comprising an electrical main storage battery and an electromechanical battery; traction motors coupled to driving wheels; a regenerative braking system; an energy dissipation system; and a control system, wherein the prime mover system provides primary power to operate the traction motors, the main storage battery provides alternate power to operate the traction motors, and the electromechanical battery provides a power boost to operate the traction motors, wherein the regenerative braking system provides power to charge the main storage battery and the electromechanical battery, and wherein the control system determines when the main storage battery should be charged and discharged, whereby pollutants are minimized and fuel efficiency is maximized.

Still further disclosed is a hybrid propulsion system, including a prime mover system; a driving system; an energy storage system; a regenerative braking system; and a control system usable to control operation of the prime mover, driving, energy storage, and regenerative braking systems, wherein the control system receives inputs of geographic location, speed, and terrain features, and manages energy discharge and charge operations.

### DESCRIPTION OF THE DRAWINGS

The detailed description will refer to the following drawings in which like numerals refer to like items and in which:

FIG. 1 is a block diagram of an exemplary hybrid propulsion system;

FIG. 2 is a diagram of an exemplary hybrid propulsion system as implemented on a railroad locomotive;

FIGS. 3A-3C illustrate an exemplary modularized alternative hybrid locomotive;

FIGS. 4A and 4B illustrate exemplary electrical distribution systems used with the locomotive of FIG. 2;

FIGS. 5A-5E illustrate construction details of a main storage battery and associated support system and cooling system for use with the locomotive of FIG. 2;

FIGS. 6A-6D illustrate an electromechanical battery system used with the locomotive of FIG. 2;

FIG. 7 illustrates a regenerative braking system used with the locomotive of FIG. 2; and

FIG. 8 is a block diagram of a predictive power management control system used with the locomotive of FIG. 2.

### DETAILED DESCRIPTION

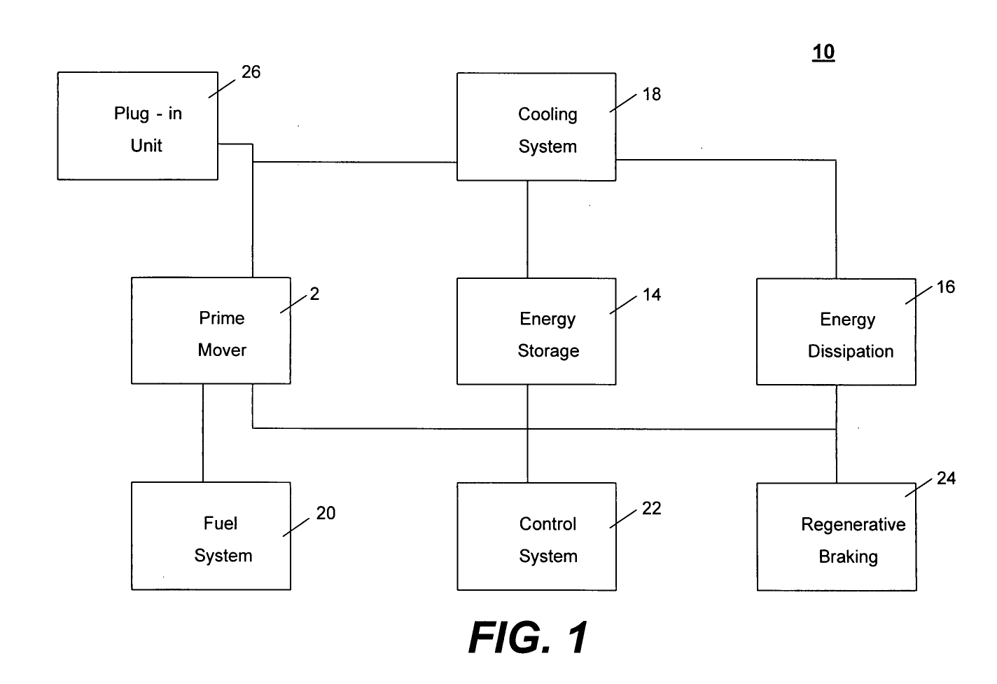

FIG. 1 is a block diagram of an exemplary hybrid propulsion system 10, which can be used to propel a variety of vehicles. The system 10 includes prime mover 12, energy storage unit 14, energy dissipation unit 16, cooling system 18, fuel system 20, control system 22, regenerative braking system 24, and optional plug-in electrical unit 26. The prime mover 12 may be any device capable of generating AC or DC electrical power. Examples of the prime mover 12 include internal combustion engines such as diesel engines, Stirling engines, and spark ignition engines, gas turbine engines, and microturbines, all mated to suitable electrical generators; and fuel cells. In an embodiment, the prime mover 12 is an engine optimized to burn ethanol, butanol, or alcohol blends, or hydrogen. The energy storage unit includes an electrical storage device, which may be a lead-acid storage battery, for example, and a mechanical-electrical storage unit. The energy storage unit is charged by operation of the prime mover 12 and the regenerative braking system 24. The energy dissipation unit 16 includes a resistive grid, which receives excess energy from the regenerative braking system 24. The cooling system provides cooling for the energy storage unit 14 and the prime mover 12. The fuel system includes a fuel tank and distribution system that supplies fuel to the prime mover 12. The control system 22 controls propulsive operations of the vehicle 10 by balancing operation of the prime mover 12, the energy storage unit 14, and the regenerative braking system 24. The control system 22 may include a speed control system to allow the vehicle to operate at a constant speed. The regenerative braking system uses the mechanical energy created during braking or slowing of the vehicle 10 to charge the energy storage unit 14. Optional plug-in electrical unit 26 allows the energy storage units to be charged off an electrical grid that may be connected to the vehicle 10 when the vehicle 10 is stationary. The above-described components may be assembled in a modularized arrangement and installed on an existing or modified railroad locomotive frame to provide greatly improved efficiency and reduced emissions compared to conventional locomotives.

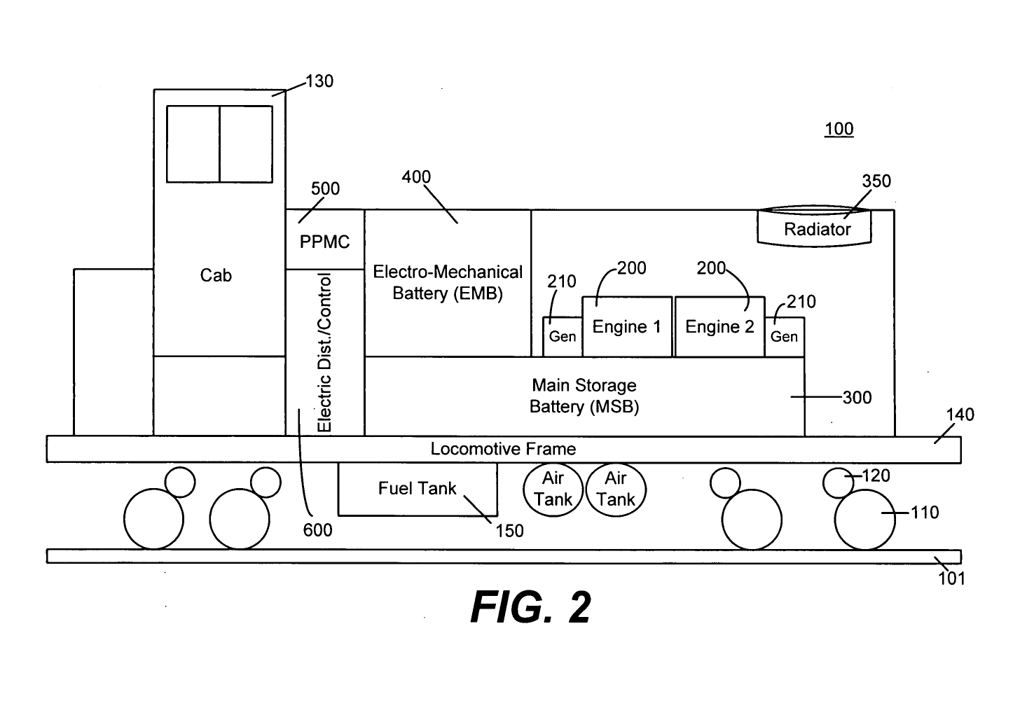

FIG. 2 shows a typical arrangement of the principal components of an embodiment of an alternative hybrid locomotive. In FIG. 2, locomotive 100 includes driving wheels 110, which are in contact with rail 101. The driving wheels 110 are driven by traction motors 120. The traction motors receive electrical power through an electrical distribution system 600, which in turn receives electrical power from generators 210. The generators 210 are rotated by engines 200, which may be cooled at least in part by cooling system 350. Fuel to power the engines 200 is provided from fuel tank 150. Also supplying electrical power to the system 600 are main storage battery (MSB) 300, and electromechanical battery (EMB) 400. Together, the MSB 300 and the EMB 400 constitute the locomotive's energy storage unit (storing electrical and mechanical energy, respectively). Other storage modules may be incorporated into the energy storage unit. Operational control of these components is facilitated in part by predictive power management control (PPMC) 500. An operator interfaces with the locomotive 100 components in cab 130. Frame 140 supports the components of the locomotive 100. Each of the above major components of the locomotive will be described later in more detail.

The engines 200 may be internal combustion engines, such as diesel engines, Stirling engines, and spark ignition engines; gas turbine engines; microturbines; and fuel cells. The internal combustion engines may operate on various blends of ethanol (e.g., 95 percent ethanol), butanol, or hydrogen. In an embodiment, the engines 200 are highly optimized to burn ethanol. Such optimization includes cylinder head design, injector design and location, compression, supercharging or turbocharging, stroke, and other factors. The engines 200 also are optimized, in terms of output power, for the particular application. For example, when the locomotive 100 is used for short haul service, the total output power of the engines 200 may range from 500 to 1,000 horsepower. Moreover, the locomotive 100 will typically include multiple engines 200. A multiple engine set allows the locomotive to operate in some conditions with only one engine 200 in operation. A multiple engine set also allows the locomotive to be upgraded with one, two, or more engines, 200, while using the same frame 140. This flexibility to deliver variable total power simplifies locomotive design, and allows later power upgrades for the locomotive 100.

As noted above, the engines 200 drive the generators 210 to produce output electrical power. Since the power out of the generators is AC, in some embodiments of the alternative hybrid locomotive, the AC power is fed to a power conversion unit (not shown) within the electrical distribution system 600, where the AC power is converted to DC power, which is then supplied to a DC bus (not shown) for distribution. The power conversion unit may be an alternator/rectifier, for example. In an embodiment in which the engines 200 and generators 210 are replaced with fuel cells, the power conversion unit may be a simple chopper or a more versatile buck/boost circuit. The MSB 300 and the EMB 400 also are connected to the DC bus. The energy storage system may also include, for example, a fast-charging battery pack, a bank of capacitors, a compressed air storage system with an air motor or turbine, or a flywheel of which a homopolar generator is an example, or a combination of these. Power from the DC bus can flow to or from the MSB 300 and the EMB 400. The DC bus can receive power for its loads simultaneously from both the generators 210 and the MSB 300 and the EMB 400. Blocking diodes in the power conversion unit ensure that power can never flow back to the generators 210. The DC bus also may transmit electrical power to an auxiliary power supply (not shown) such as might be used to operate the locomotive's lighting and braking system for example.

The motors 120 may be, for example, AC induction motors, DC motors, permanent magnet motors or switched reluctance motors. If a motor 120 is an AC motor, it receives AC power by means of an inverter (not shown) connected to the DC bus. Alternately, if the motor 120 is a DC motor, it receives DC power using, for example, a chopper circuit (not shown) connected to the DC bus. In an embodiment, the locomotive 100 uses separate armature and field drives for the traction motors 120. Using separated drives, and hence separate field controllers, allows the dynamic brake power to be put back onto the DC bus at a steady voltage because the traction motor components use separate field controllers.

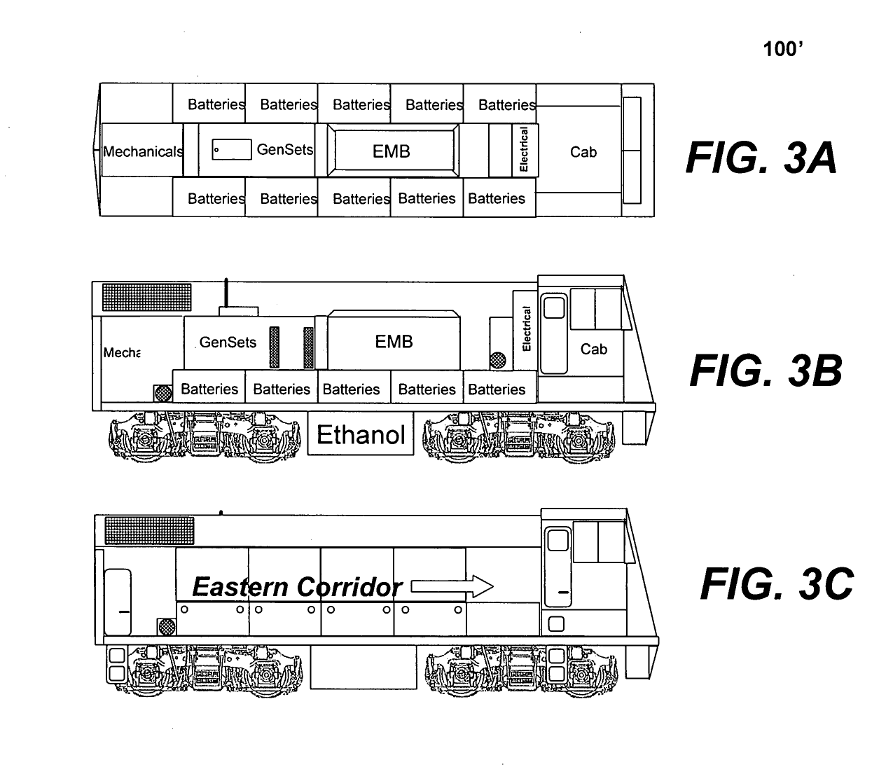

FIGS. 3A-3C illustrate an alternative hybrid locomotive 100′ having modularized components, such as those described above with respect to FIG. 2, installed on an existing locomotive frame. As illustrated, the locomotive 100′ is a passenger train locomotive. However, the modularized concepts illustrated in FIG. 3A-3C apply equally to any locomotive, regardless of service. Also, as illustrated, the locomotive 100′ is shown powered by ethanol. However, as previously noted, other fuels may be used with the locomotive 100′.

FIG. 3A is a top down view of the locomotive 100′. As can be seen, the prime mover system (gen sets) are placed above the main storage battery and aft of the electro-mechanical battery. In an embodiment, two engine/generator sets are placed back-to-back. In an alternative embodiment, the engine/generator sets are placed side-by-side. The electrical distribution system main components and the predictive power system are placed forward of the electromechanical battery. Finally, the crew cab is placed forward of these propulsion systems.

FIG. 3B illustrates the modular placement of propulsion system components from a side view, with portions of the structure (e.g., access doors) removed for clarity. FIG. 3C illustrates the locomotive 100′ with access doors for the propulsion system components closed.

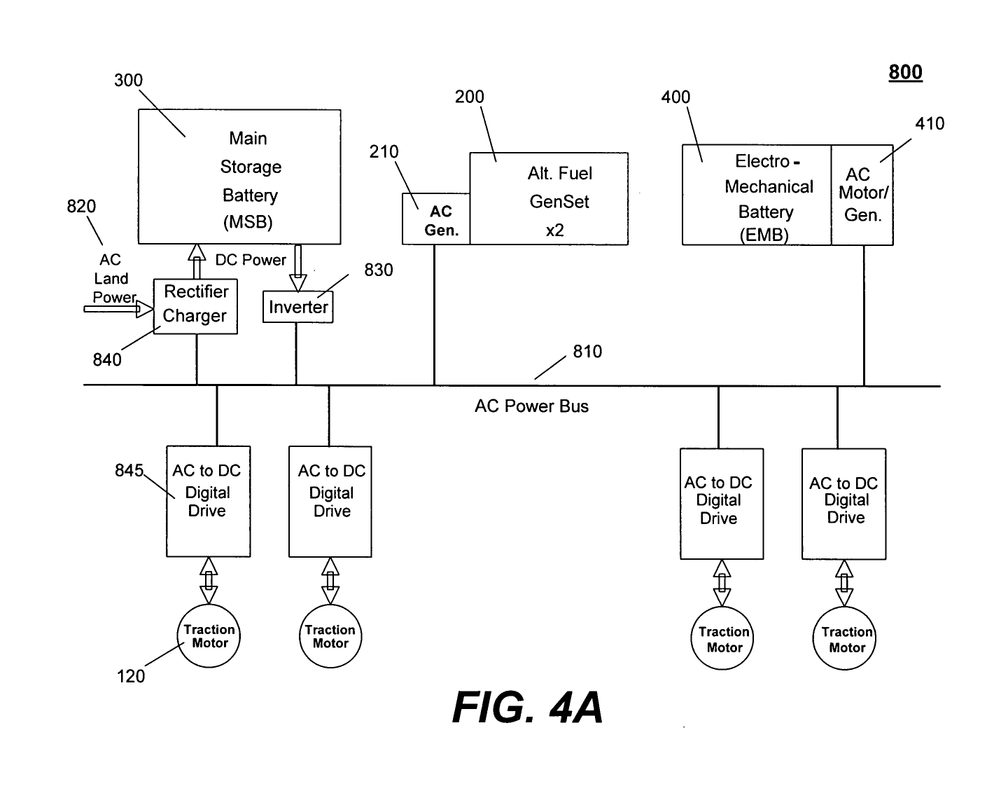

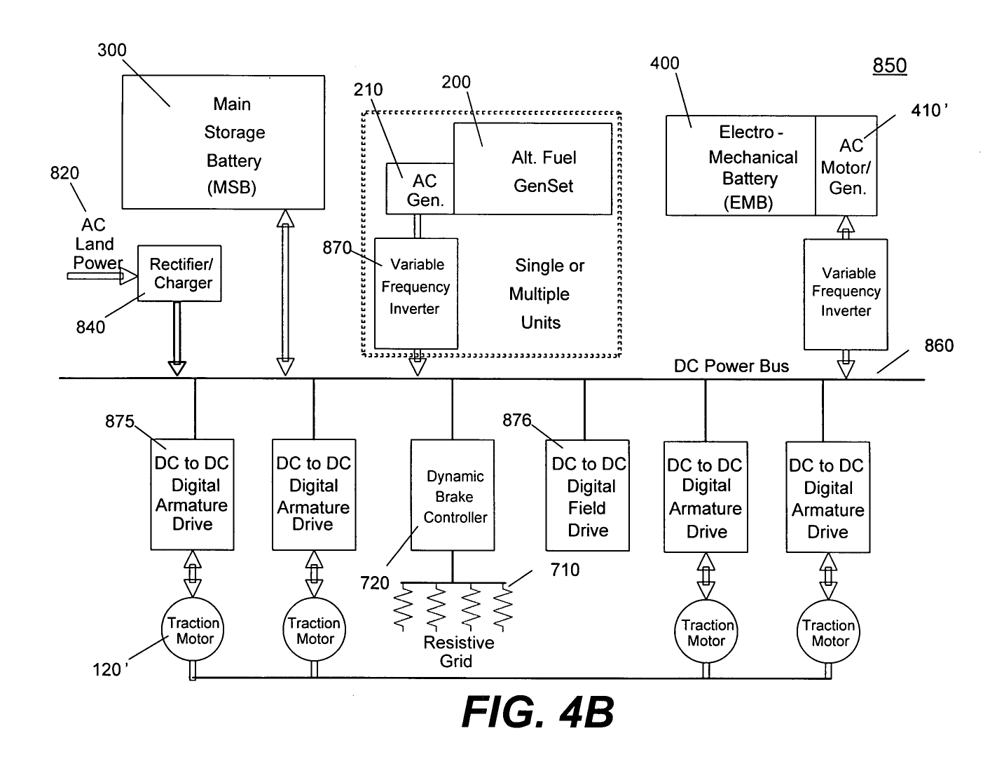

FIGS. 4A and 4B illustrate exemplary electrical distribution systems useable with the locomotive of FIG. 2. FIG. 4A illustrates AC distribution system 800, including AC distribution bus 810. The bus 810 couples the MSB 300 and the EMB 400 to the engine/generator sets (200/210) and, in the case of the MSB 300, to plug-in power 820. Power from the MSB 300 is converted from DC to AC by inverter 830 and power to the MSB 300 from either the AC bus 810 or the plug-in power 820 is converted from AC to DC by rectifier/charger 840. The traction motors 120 receive DC power from the AC/DC digital drive units 845.

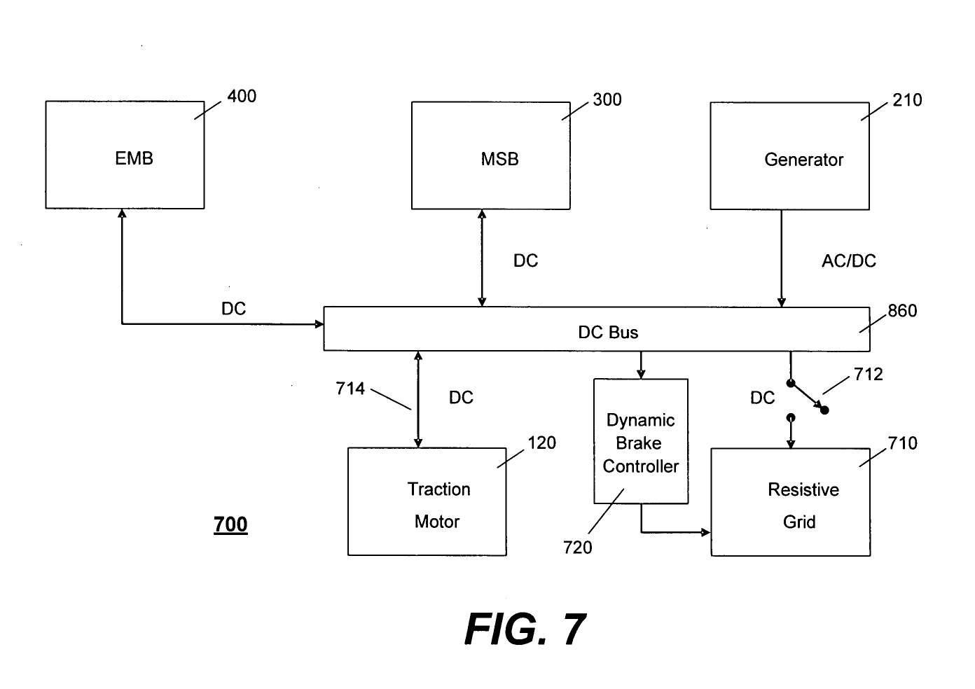

FIG. 4B illustrates DC distribution system 850, including DC distribution bus 860. The bus 860 couples the MSB 300 and the EMB 400 to the engine/generator sets (200/210) by way of variable frequency inverter 870. The variable frequency inverter 870 allows efficient power conversion from AC to DC when the engine/generator sets 200/210 operate at varying RPMs. The DC bus 860 distributes power by way of a combination of DC to DC digital armature drive units 875 and DC to DC digital field drive 876 to power DC traction motors 120′. A dynamic brake controller 720 allows dynamic braking power (discussed later with respect to FIG. 7) from the traction motors 120′ to be dissipated to resistive grid 710 when the dynamic braking power cannot be used to charge MSB 300 or EMB 400. The MSB 300 can be charged from AC land power (an AC plug-in unit) through rectifier/charger 840.

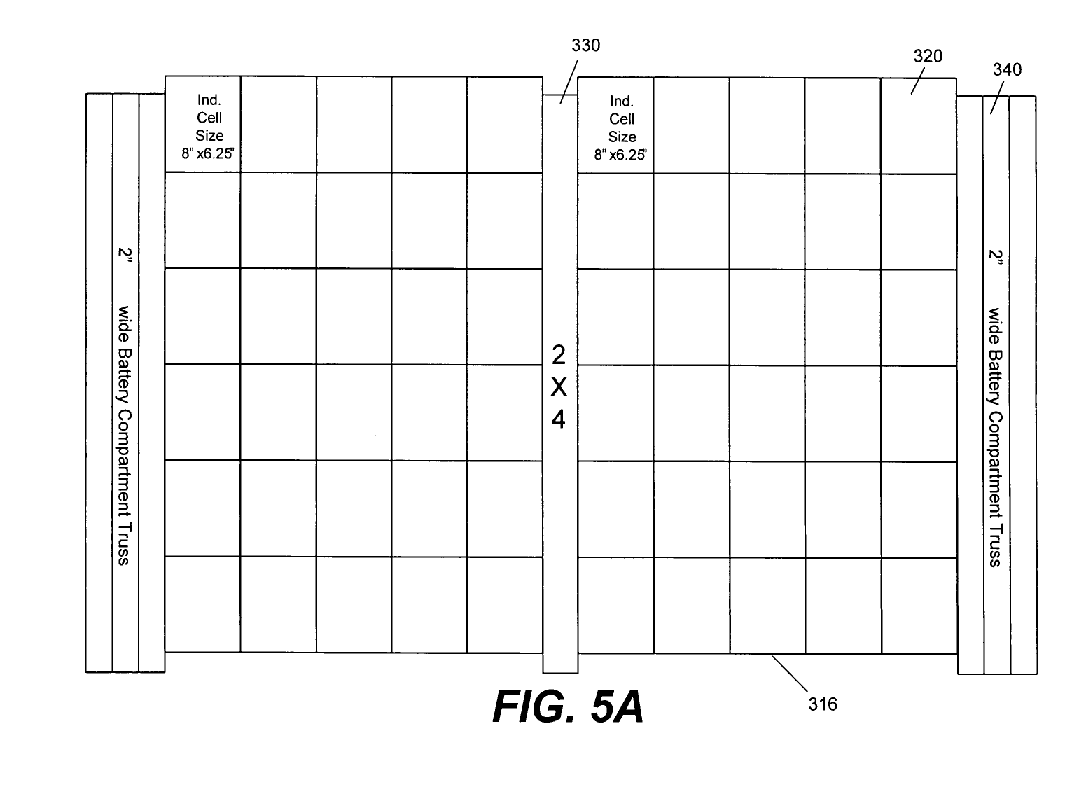

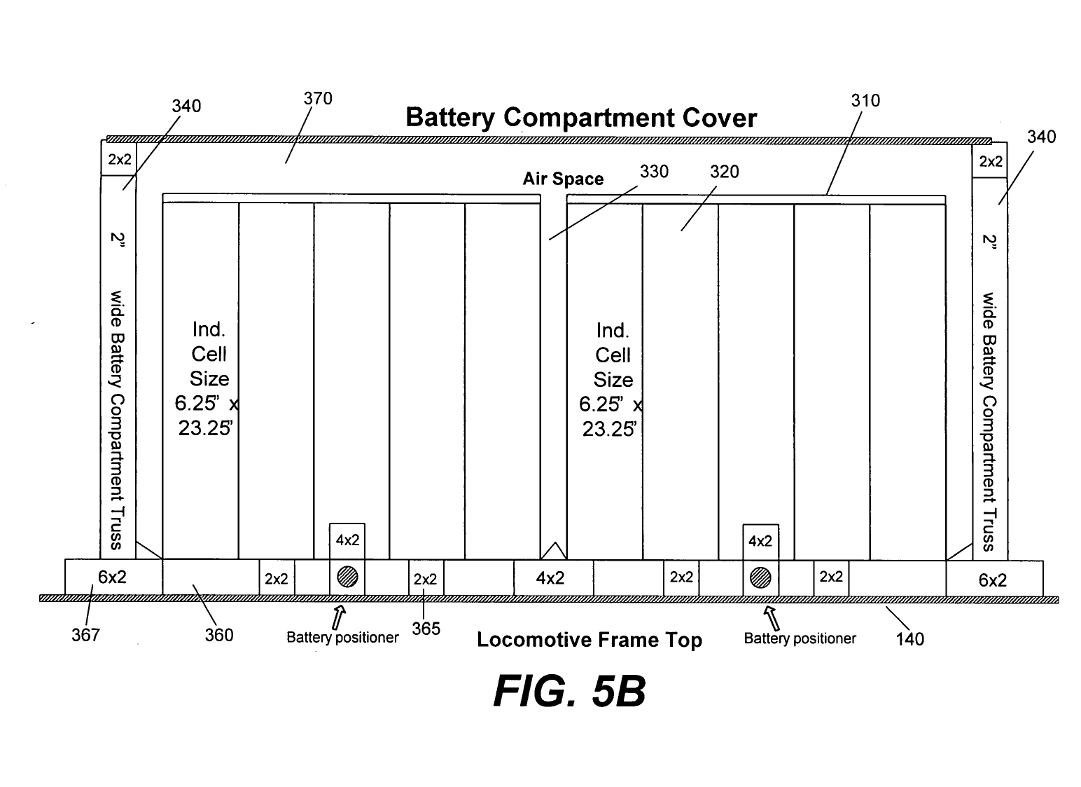

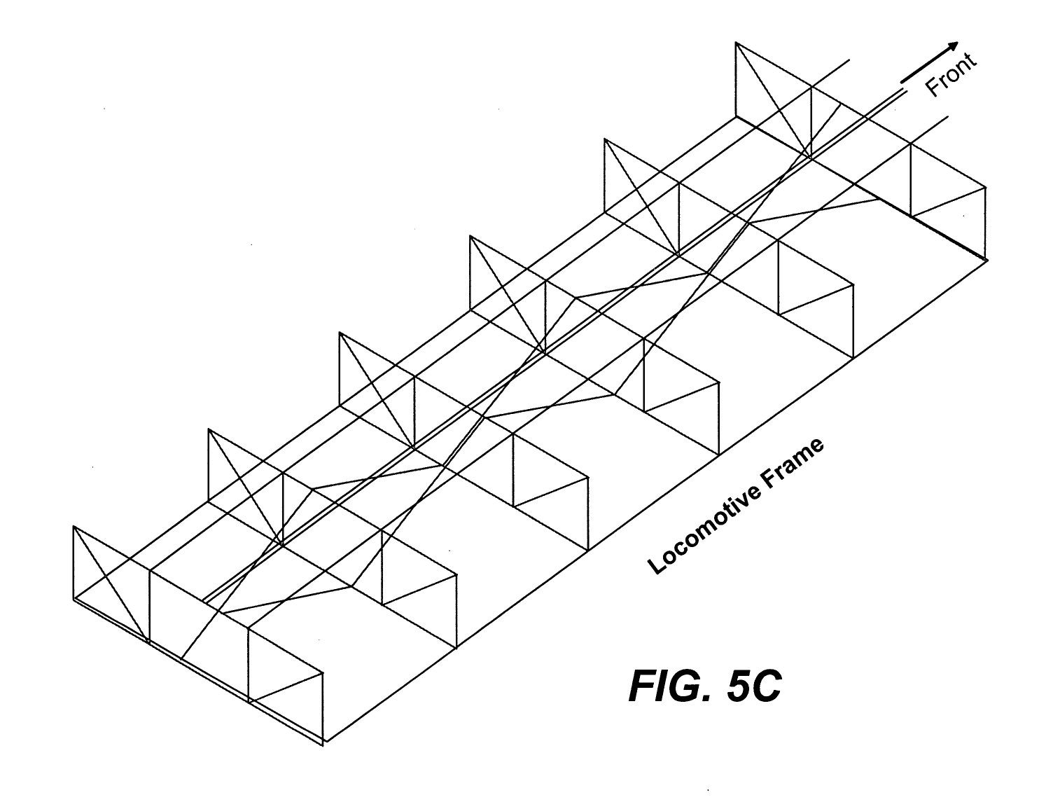

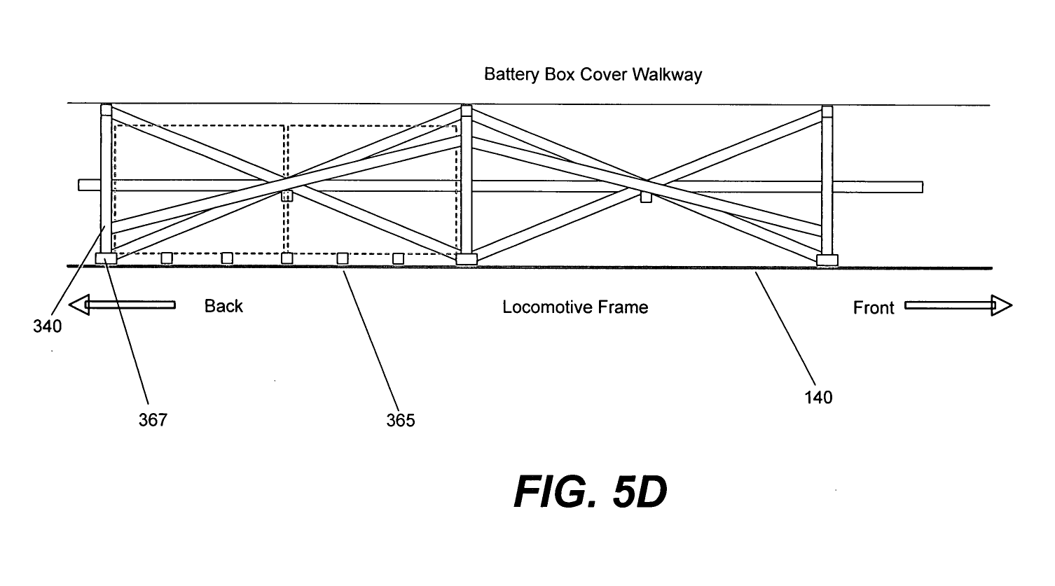

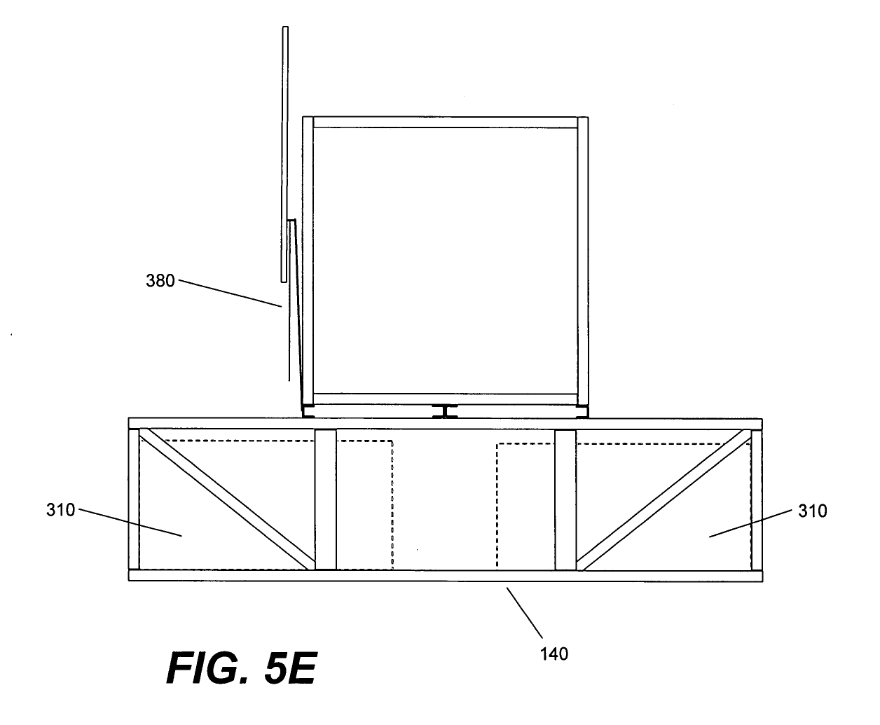

FIGS. 5A-5E illustrate construction details of the main storage battery (MSB) 300 and associated support system and cooling system for use with the locomotive 100. FIG. 5A is a top view of a section of the MSB 300. Referring back to FIG. 2, the MSB 300 is placed below the engine/generator sets and the EMB, in a subframe system that allows easy access, servicing, removal and replacement. The modular construction of the MSB 300 results in high power densities (power to weight and power to volume). In the locomotive 100 of FIG. 2, ten such sections of individual cells 320 would comprise the total MSB 300, and the MSB 300 would produce an output voltage, at full charge, of 600 volts (nominal). FIG. 5A illustrates a typical battery cell arrangement in which trays 310 include 30 individual battery cells 320. The trays 310 are individually removable from the locomotive 100 as modular units. In FIG. 5A, the trays 310 are separated from each other by center duct 330, and are braced on their exterior by trusses 340. The dimensions illustrated in FIG. 5A are exemplary, and other dimensions may be used for the illustrated systems, components, and structures.

FIG. 5B is a front view of a section of the MSB 300 showing two trays 310 of individual cells 320. Also shown in FIG. 5B is a support arrangement that facilitates cooling of the battery cells 320. Specifically, supports 365 separate the bottoms of the cells 320 from the locomotive's frame 140 (see FIG. 2), thereby creating an air passageway 360. Ventilation fans (not shown) installed above center duct 330 draw air from below the cells 320 (i.e., through passageway 360) through the center duct 330, and out above the cells 320 through airspace 370. The trusses 340 are also supported off the frame 140 by supports 367. In addition, the trusses include a separation member 369 that separates the upper portions of the air spaces from the lower spaces, thus enabling the counter-clockwise/clockwise flow of air shown.

FIG. 5C illustrates the overall support structure for five sections of battery cells 120.

FIG. 5D is a side view of the battery cell support structure.

FIG. 5E is a sectional view of the locomotive 100 showing the battery compartment with trays 310 installed, and access door 380 shown in the open position.

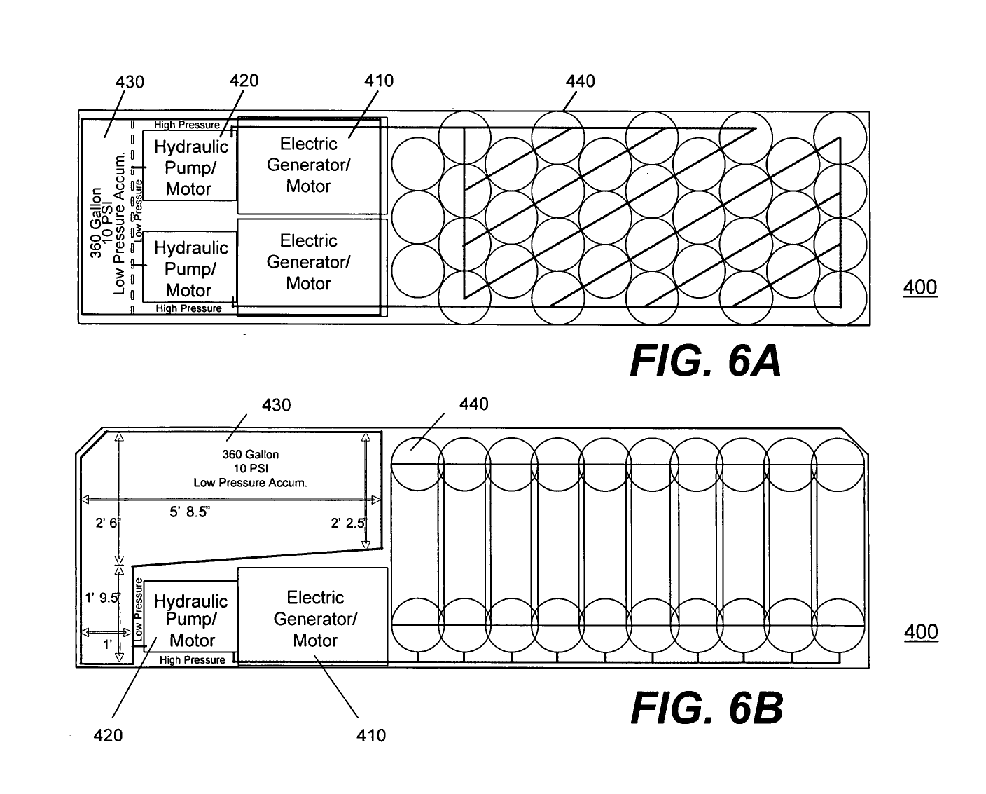

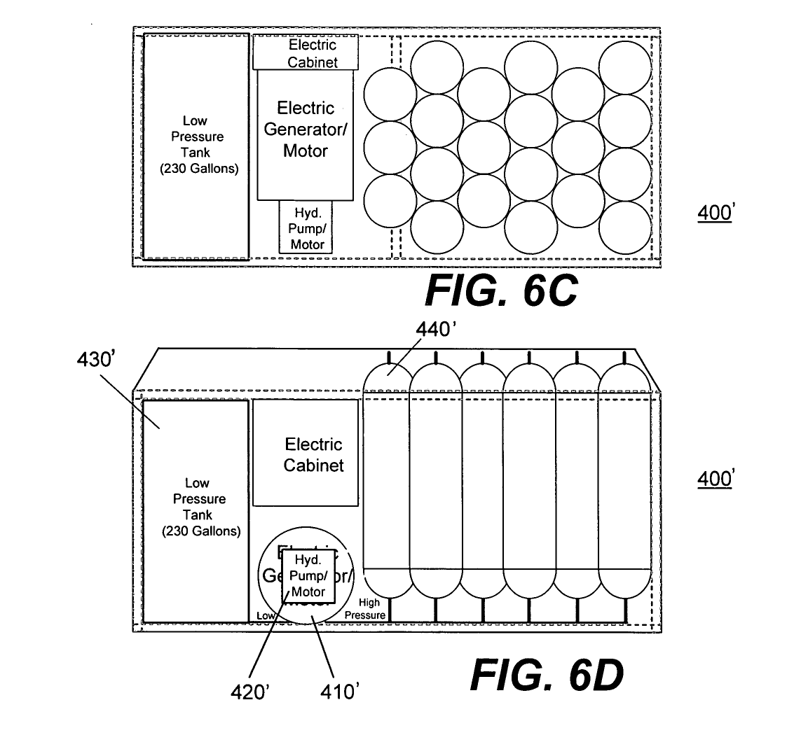

FIGS. 6A-6D illustrate exemplary configurations of an electromechanical battery system for use with the locomotive 100. In FIGS. 6A and 6B, EMB 400 includes motor/generator 410, which may be an AC or a DC generator, hydraulic pump/motor 420, low pressure accumulator 430 and high pressure accumulator bank 440. The motor/generator 410, as shown in FIGS. 6A and 6B, receives either AC or DC power in a charging mode and supplies AC or DC power in a discharge, or boost, mode. The received electrical power operates the motor/generator 410 to, in turn, operate hydraulic pump/motor 420. In the charge mode, the pump/motor 420 pumps hydraulic fluid from the low pressure accumulator 430 into individual high pressure accumulators in accumulator bank 440. Pumping the fluid into the accumulator bank 440 pressurizes the accumulators as a nitrogen, or similar inert gas-containing bladder or compartment with in an individual high pressure accumulator is compressed. When fully charged, the accumulator bank 440 contains a supply of high pressure hydraulic fluid with a specific potential energy that may be used to power the locomotive 100 for a short time (i.e., to boost locomotive power, such as during starting the train). The potential energy in the accumulator bank 440 is released when the pump displacement is reversed. In this boost mode, the pump/motor 420 operates as a motor to turn the motor/generator 410 to produce AC or DC energy. In operation, the EMB 400 should produce useable electric power for about several minutes.

FIGS. 6C and 6D illustrate an alternate EMB configuration 400′, with a lower total power output, as might be satisfactory on a switching locomotive, for example.

FIG. 7 illustrates an exemplary regenerative braking system 700 used with the locomotive 100. The regenerative braking system 700 operates in conjunction with the DC bus 860 of FIG. 4B (or the AC bus of FIG. 4A) to allow power to flow from one or more power sources (e.g., the generators 210, the MSB 300, and the EMB 400) to the traction motors 120 and other motors when the voltage level of any of the power sources is higher than the operating voltage of the traction and other motors. The traction motors may be AC or DC motors. If the traction motors 120 are AC traction motors, the inverter or inverters act as rectifiers when the traction motors are operated as generators. The various embodiments of the locomotive 100 will be described primarily with reference to DC traction motors. When braking, the traction motors 120 can be operated as generators to supply power to the DC bus 860 if the output voltage of the traction motors 120 operated as generators is higher than the voltage across all the power sources. The regenerative braking power also can flow to the resistive grid 710 to be dissipated (this is the main sink for braking energy in dynamic braking). In the locomotive 100, regenerative braking power can also flow into the energy storage systems as long as the voltage across the energy storage systems is less than the voltage on the DC bus, which is established by the output voltage of the traction motors operating as generators.

During motoring mode of the locomotive 100, power flows from one or both of the prime power and the energy storage units to the DC bus 860, where the DC bus supplies power to a motor 120 through a power conversion apparatus. During the braking mode of the locomotive 100, the motor 120, now acting as generator, can reverse the flow of power to supply power to the DC bus 860, which in turn then can provide recharging energy to MSB 300 and the EMB 400. If, during the braking mode of the locomotive 100, there is an excess of regenerative energy from motor 120, this excess can be diverted away from the energy storage units and dissipated in the resistive grid 710 by, for example, either by closing optional switch 712 or by controlling power to the resistive grid 710 through the dynamic brake controller 720.

In both the motoring and braking modes, the DC bus 860 has a predetermined bus voltage level that controls the amount of power flow from the various prime mover and/or energy storage power supplies to the motors and from the dynamic and/or regenerative braking circuits to the energy storage devices and/or power dissipating circuits. In addition, the power flow to or from the DC bus by the motor and resistive grid circuits may be controlled independently of the DC bus voltage by one or more power control units between the bus and the motors and the bus and the resistive grid. In the motoring mode, the output voltage level of the bus is controlled by the power source or power sources that generate the highest DC voltage. Each power supply has its own well-known means of regulating its output voltage so that each power supply can be controlled to provide an output voltage that allows the power supply to be engaged or disengaged at will from the power flow to the DC bus. The power flow from the DC bus to the motors driving the wheels is regulated by independent control of the voltage supplied to the motors using, for example, inverters or choppers. This architecture therefore does not require synchronization of power supplies nor are the power supplies used to regulate the power required by the wheel driving motors. This architecture therefore permits the use of various numbers and types of power supplies (both prime power and energy storage apparatuses) to be used in conjunction with various types of motors and drive train configurations without special modification to the power supplies, the drive motors or the control circuitry.

By using the same voltage control principal in the braking mode, the flow of power from the motor/generator circuits to the energy storage devices and/or dissipating dynamic braking resistance grids can be controlled. For example, power will only flow from the motor/generator circuits to the DC bus when the motor/generator circuit voltages exceed the bus voltage, which will tend to be stable at or near the battery voltage when the MSB 300 is used as the energy storage device. When the amount of power from the motor/generator circuit is too large to be absorbed by the energy storage device (such as determined by the charge level, current flow or voltage level of the battery), the switch to the dissipating resistance grid 710 can be closed (for example when a predetermined DC bus voltage is exceeded or when a predetermined battery charge and/or current level is exceeded) and the excess power will be dissipated in the resistive grid 710, or the dynamic brake controller 720 can be used to more precisely control the excess power flow to the resistive grid 710.

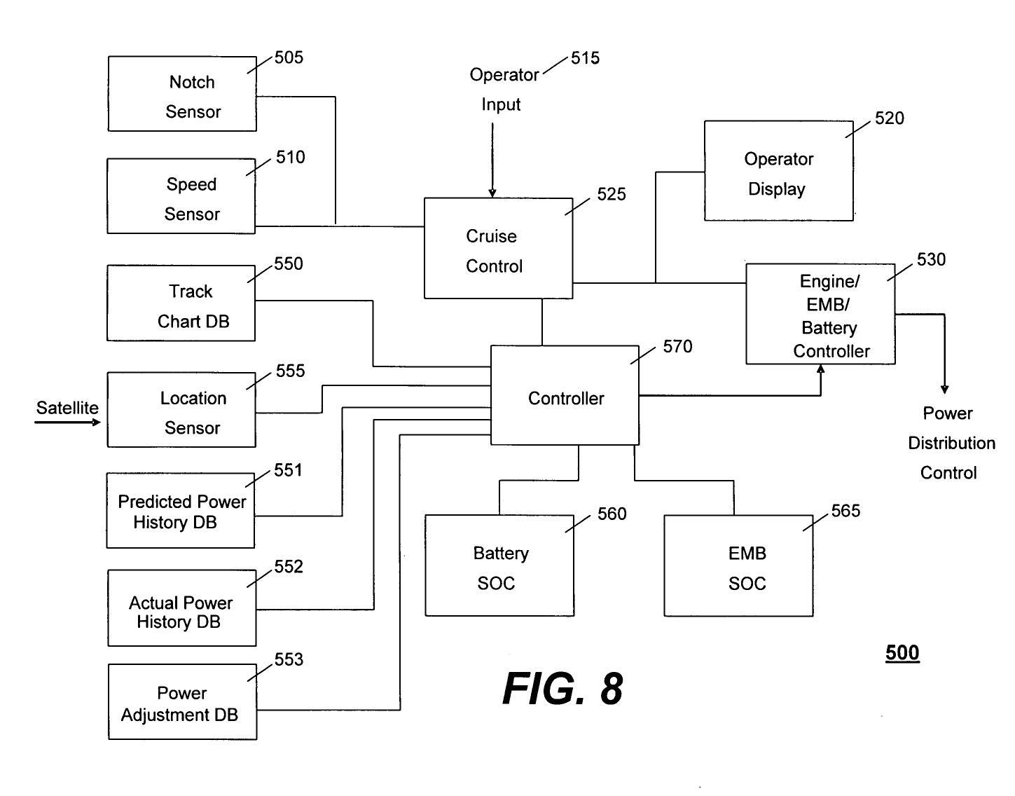

FIG. 8 is a block diagram of a predictive power management control (PPMC) system 500 used with the locomotive 100. The PPMC 500 includes notch sensor 505 to detect the notch setting of the locomotive's throttle, speed sensor 510 to detect the speed of the locomotive, and location sensor 555 to detect the location of the locomotive 100. The location sensor 555 may receive an input from a GPS satellite, and may use a dead reckoning analyzer, in addition or in lieu of the GPS satellite, particularly where satellite reception is poor. Cruise control 525 receives a manual setting 515 from the train operator, as well as inputs from the notch sensor 505 and the speed sensor 510. The cruise control 525 outputs a signal to the various power devices (EMB 400, MSB 300, and engine/generator 200/210 depending on the sensed notch setting and speed setting. For example, if the notch setting produces a power output of the generator 210 that is more than that required for the selected speed 515 (as detected by the speed sensor 510), then the cruise control 525 (when in operation) will cause the EMB 400 or the MSB 300 to produce power so that the locomotive 100 operates at the selected speed. If the notch setting produces a power output less than that required for the selected speed, the throttle notch setting will take precedence over the selected speed setting and the operator will receive a warning message on operator display 520.

The cruise control 525 also can reconfigure operation of the engine/generator sets so that the appropriate power output is maintained without accelerating/decelerating the locomotive 100 as would normally happen using only notch control. The cruise control 525 also provides an output 520 to the operator when the cruise control determines that the selected notch setting is not appropriate for the locomotive's operation.

The location sensor 555 output combines with an output from a track chart database 550 and a power adjustment database 553 so that the PPMC 500 can predict power requirements based on changes in grade, length of track, track speed limits, previous trips over the same track, and other conditions. The power adjustment database 553 receives inputs from a predicted power history database 551 and an actual power history database 552. For example, during a trip over a specific track section, the PPMC 500 will detect and store actual power requirement in the actual power history database. The predicted power history database 551 receives power predictions based on locomotive speed and other operating conditions, as well as locomotive location relative to data in the track chart database 550. Using these inputs, as well as the state of charge of the EMB 400 and the MSB 300 (665/560, respectively) the controller 570 may, for example, determine that the locomotive 100 is about to enter a down slope area, and that the MSB 300 can wait to be charged until such time, when the regenerative braking system operates to slow the train. As another example, the controller 570 may determine that the locomotive has only a short distance to travel before returning to a rail yard where a plug-in power unit can be used to recharge the locomotive's MSB 300, at a considerably reduced cost relative to charging the MSB from the generators 210.

The combination of the track chart database 550 and the location sensor 555 can also be used to determine when a switch over to all battery operation, for example, is desired. Such a mode may be preferred in areas that require reduced pollutant emissions and/or reduced noise emission. These changes in propulsive operations are directed to the engine/generator sets, the EMB, and the MSB, through the control engine/EMB battery controller 530.

The predicted power requirements as well as actual power setting utilized are stored in a predicted power history database 551 and an actual power history database 552 for analysis by the PPMC 500. Based on the analysis, a power adjustment database 553 is created and maintained for use by the PPMC 500 in order to make optimized adjustments to the power control and distribution settings.

I claim:

1. A locomotive propulsion system, comprising:
one or more engine/generator sets, wherein engines of the engine/generator sets operate by burning one or more of ethanol, butanol, alcohol, and blends thereof, and hydrogen;
traction motors electrically coupled to the engine/generator sets, wherein the traction motors operate in a motor mode to drive wheels to propel a locomotive, and operate in a generator mode to generate electrical power during locomotive braking periods;
a main storage battery coupled to the engine/generator sets and the traction motors, wherein the engine/generator sets operate to provide an electrical charge to the main storage battery, wherein the traction motors operate in the generator mode to charge the main storage battery, and wherein the main storage battery provides electrical power to the traction motors;
an electromechanical battery coupled to the electrical/generator sets and the traction motors, wherein the traction motors operate in a charging mode to charge the electromechanical battery, and wherein the battery operates in a boost mode to drive the traction motors;
an energy dissipation unit coupled to the traction motors and operable to dissipate excess electrical power; and
a predictive power system that uses locomotive location and mode of operation to determine an appropriate locomotive power setting.

2. The system of claim 1, wherein the predictive power system comprises:
a location sensor that receives locomotive location information;
a notch sensor that detects locomotive throttle setting information;
a speed sensor that senses locomotive speed; and
a cruise control unit that receives inputs from the notch sensor and the speed sensor and provides a control signal to the engine generator sets to maintain a power level that avoids accelerating and decelerating.

3. The system of claim 2, wherein the cruise control provides a signal to an operator when a selected notch setting is not appropriate for the locomotive's operation.

4. The system of claim 2, wherein the predictive power system determines, based on the locomotive location information, when the main storage battery should operate to power the traction motors.

5. The system of claim 2, wherein the predictive power system determines, based on the locomotive location information, when the engine/generator sets should operate to charge the main storage battery.

6. The system of claim 2, wherein the predictive power system determines, based on the locomotive location information, when the traction motors should operate to charge the main storage battery.

7. The system of claim 2, wherein predictive power system further comprises a dead reckoning analyzer and a GPS receiver, and wherein the locomotive location information is based on one or more of dead reckoning and GPS positioning.

8. The system of claim 2, wherein the predictive power system further comprises:
means for predicting power requirements and storing the predicted power requirements;
means for determining and storing actual power requirements; and
means for computing and storing power adjustments based on the predicted power requirements and the actual power requirements, wherein the power adjustments are useable to control power distribution within the locomotive propulsion system.

9. The system of claim 1, further comprising a plug-in power unit to charge the main storage battery.

10. The system of claim 1, wherein the electromechanical battery comprises:
an electrical motor/generator;
a hydraulic pump/motor coupled to the electrical motor/generator; and
inert gas accumulators coupled to the hydraulic pump/motor, wherein the accumulators store potential energy to provide a boost for operation of the traction motors.

11. The system of claim 10, wherein the accumulators comprise low pressure and high pressure accumulators.

12. A hybrid propulsion system for a locomotive, the locomotive operating in one of a motoring mode and a braking mode, the system, comprising:
a prime mover system comprising internal combustion engines coupled to electrical generators;
an energy storage system comprising an electrical main storage battery and an electromechanical battery;
traction motors coupled to driving wheels;
a regenerative braking system;
an energy dissipation system; and
a control system,
wherein the prime mover system provides primary power to operate the traction motors, the main storage battery provides alternate power to operate the traction motors, and the electromechanical battery provides a power boost to operate the traction motors,
wherein the regenerative braking system provides power to charge the main storage battery and the electromechanical battery, and
wherein the control system determines when the mains storage battery should be charged and discharged, whereby pollutants are minimized and fuel efficiency is maximized.

13. The system of claim 12, further comprising a modular mounting structure for restraining system components, the mounting structure, comprising:
means for facilitating modular removal and replacement of the system components;
means for maximizing power density of the system components; and
means for effectively cooling the system components.

14. The system of claim 12, wherein the traction motors are alternating current machines.

15. The system of claim 12, wherein the traction motors are direct current machines.

16. The system of claim 12, wherein the energy dissipation system is a resistive grid.

17. The system of claim 12, further comprising means for controlling the flow of power among the system components.

18. The system of claim 12, wherein the control system comprises:
means for detecting locomotive speed and location;
means for detecting locomotive notch setting; and
means for configuring operation of the prime mover system and the energy storage system to maintain a desired power output without accelerating and decelerating the locomotive.

19. The system of claim 18, further comprising:
means for predicting power requirements and storing the predicted power requirements;
means for determining and storing actual power requirements; and
means for computing and storing power adjustments based on the predicted power requirements and the actual power requirements, wherein the power adjustments are useable to control power distribution within the hybrid propulsion system.

20. The system of claim 19, wherein the means for predicting power requirements comprises a track chart system usable by the control system to predict power generation and power storage requirements.

21. A hybrid propulsion system, comprising:
a prime mover system;
a driving system;
an energy storage system;
a regenerative braking system; and
a control system usable to control operation of the prime mover, driving, energy storage, and regenerative braking systems, wherein the control system receives inputs of geographic location, speed, and terrain features, and manages energy discharge and charge operations.

22. The system of claim 21, wherein the system is controlled to reduce emission of pollutants, to maximize fuel efficiency, and to reduce noise emissions.

23. A method for operating a hybrid propulsion system, comprising:
using a projected track and a determined location, predicting propulsion system power requirements;
using prior power requirements, determining a power history for the projected track;
using the power history and the predicted power requirements, determining power adjustments for the hybrid propulsion system; and
applying the power adjustments during operation of the hybrid propulsion system.
